(19) United States
(12) Patent Application Publication
(10) Pub. No.: US 2022/0339976 A1
(43) Pub. Date: Oct. 27, 2022

(54) TIRE COMPRISING A RADIOFREQUENCY TRANSPONDER

(71) Applicant: COMPAGNIE GENERALE DES ETABLISSEMENTS MICHELIN, Clermont-Ferrand (FR)

(72) Inventors: JULIEN DESTRAVES, Clermont-Ferrand (FR); SEBASTIEN FREDON, Clermont-Ferrand (FR); PIERRE GUINAULT, Clermont-Ferrand (FR); EMMANUEL JOULIN, Clermont-Ferrand (FR); LAURENT COUTURIER, Clermont-Ferrand (FR)

(21) Appl. No.: 17/763,432

(22) PCT Filed: Sep. 22, 2020
(86) PCT No.: PCT/FR2020/051650

§ 371 Date: Mar. 24, 2022

(30) Foreign Application Priority Data
Sep. 25, 2019 (FR) FR1910572

(51) Int. Cl. B60C 19/00; B60C 15/00; H01Q 1/22; H01Q 7/00; H01Q 9/16

(52) U.S. Cl. CPC B60C 19/00; B60C 15/0018; H01Q 1/2241; H01Q 7/00; H01Q 9/16; B60C 2015/0617

(57) ABSTRACT

A tire fitted with a transponder comprises: a crown comprising a crown reinforcement having an axial end at each of its edges, connected at each of its axial ends by a sidewall to a bead having an interior end; a carcass reinforcement, formed of adjacent first threads, which is anchored in each bead around a spiral formed by second threads; and the transponder comprising a dipole antenna consisting of a spring defined by a pitch P and a diameter D. A ratio between the pitch (P1) and the diameter (D1) for a loop of a first region of the spring is greater than 0.8, and the transponder is situated axially on the outside of an interior end of the bead and radially between the upper end of the spiral and the axial end of the crown reinforcement.

### FIELD OF THE INVENTION

The present invention relates to a tyre casing fitted with an electronic radio identification device or radiofrequency transponder which, particularly in service when mounted on a land vehicle, is subjected to severe thermomechanical stresses.

### TECHNOLOGICAL BACKGROUND

In the field of RFID devices (RFID being the acronym of RadioFrequency IDentification), passive radiofrequency transponders are conventionally used to identify, track and manage objects. These devices allow more reliable and faster automated management.

These passive radiofrequency-identification transponders generally consist of at least one electronic chip and one antenna formed by a magnetic loop or a radiating antenna, which is fastened to the object to be identified.

The communication performance of the radiofrequency transponder is expressed in terms of the maximum distance of communication of the radiofrequency transponder with a radiofrequency reader, for a given signal communicated to or by the radiofrequency reader.

In the case of highly extensible products such as, for example, tyres, there is a need to identify the product throughout its life from its manufacture to its removal from the market and, in particular, during use thereof. Thus, in order to facilitate this task, in particular under the conditions of use on a vehicle, a high communication performance is required, which is expressed in terms of the ability to interrogate the radiofrequency transponder at a large distance (several metres) from the product, via a radiofrequency reader. Lastly, it is desired for the manufacturing cost of such a device to be as competitive as possible.

A passive radiofrequency-identification transponder able to meet the needs of tyres is known in the prior art, and in particular from document WO 2016/193457A1. This transponder consists of an electronic chip, connected to a printed circuit board to which is galvanically connected a first primary antenna. This primary antenna is electromagnetically coupled to a single-strand helical spring that forms a radiating dipole antenna. The communication with an external radiofrequency reader for example uses radiowaves and in particular the UHF band (UHF being the acronym of Ultra-High Frequency). Therefore, the characteristics of the helical spring are adjusted for the chosen communication frequency. Thus, the disappearance of the mechanical junction between the printed circuit board and the radiating antenna improves the mechanical resistance of the radiofrequency transponder.

However, such a passive radiofrequency transponder exhibits weaknesses in its use when incorporated into a tyre casing. Although this radiofrequency transponder is suitable for operating at the communication frequency of the external radiofrequency reader, the radiofrequency communication via the radiating antenna is not optimal, in particular for long-distance interrogations. In addition, it is also necessary to give consideration to how the radiating antenna will behave mechanically in an environment that is highly stressful themomechanically. Thus, it is necessary to optimize the performance-related compromise between the mechanical strength of the antenna and its radiocommunication efficacy, such is its radio electric performance and, secondarily, its electromagnetic performance, in order to optimize the potential performance of such a passive radiofrequency transponder while preserving the endurance of the tyre casing.

The present invention relates to a tyre casing fitted with a passive radiofrequency transponder aimed at improving the performance-related compromise, and in particular the radiocommunication performance of passive radiofrequency transponders used in a tyre design when used on a vehicle.

### DESCRIPTION OF THE INVENTION

The invention relates to a tyre casing that is toroidal in shape about a reference axis and equipped with a passive radiofrequency transponder. The tyre casing comprises:
a crown block comprising a crown reinforcement having an axial end at each of its edges, and a tread, connected at each of its axial ends to a bead having an interior end situated axially and radially on the inside of the bead with respect to the reference axis, by a sidewall,
first threads forming outward and return portions arranged adjacent to one another, aligned circumferentially, anchored in said beads with, in each bead, loops each connecting an outbound and a return portion, said first threads forming at least one circumferential alignment defining a carcass reinforcement dividing the tyre casing into two regions, inner and outer with respect to the carcass reinforcement,
in each bead, means of anchoring said first threads comprising second threads oriented circumferentially and axially bordering the first threads and forming at least one spiral,
a first layer of elastomer compound forming the exterior surface of the tyre casing in the region of the bead, said first layer of elastomer compound being intended to come into contact with the rim,
a second layer of elastomer compound situated radially on the outside in contact with the first layer of elastomer compound forming the exterior surface of said sidewall,
the passive radiofrequency transponder comprising an electronic portion and a radiating dipole antenna,
the radiating dipole antenna consisting of a single-strand helicoidal spring defining a helix pitch P, a winding diameter D, a midplane and a wire diameter defining an interior diameter and an exterior diameter of the radiating antenna, of which the length is designed to communicate on a frequency band with a radiofrequency reader defining a first longitudinal axis, a central region and two lateral regions along the first longitudinal axis,
the electronic portion comprising an electronic chip and a primary antenna of coil type comprising at least one turn, and thus defining a second longitudinal axis and a midplane perpendicular to the second longitudinal axis,
the primary antenna being galvanically connected to the electronic chip and electromechanically coupled to the radiating dipole antenna and being circumscribed by a cylinder of which the axis of revolution is parallel to the second longitudinal axis and of which the diameter is greater than or equal to one third of the interior diameter of the radiating antenna situated plumb with the primary antenna,
the passive radiofrequency transponder being arranged in such a way that the first and second longitudinal axes are parallel and that the midplane of the primary antenna is positioned in the central region of the helical spring.

The tyre casing is characterized in that, with the radiating dipole antenna comprising a first region in which the radiating dipole antenna is not situated plumb with the electronic portion, the ratio between the helix pitch P1 and the winding diameter D1 for at least one loop of the helical spring in the first region is greater than 0.8, in that the radiating dipole antenna is situated plumb with the at least two first threads of the carcass reinforcement, and in that the passive radiofrequency transponder is situated axially on the outside relative to the interior end of the bead and radially between the radially outermost end of the at least one spiral and the axial end of the crown reinforcement, preferably on the inside of the tyre casing.

Here, the term “elastomer” is understood to mean all the elastomers including TPEs (acronym of ThermoPlastic Elastomers), such as for example diene polymers, i.e. polymers comprising diene units, silicones, polyurethanes and polyolefins.

Here, the term “electromagnetic coupling” is understood to mean coupling via electromagnetic radiation, i.e. the transfer of energy without physical contact between two systems including, on the one hand, inductive coupling and, on the other hand, capacitive coupling. The primary antenna is then preferably comprised in the group comprising: a coil, a loop or a wire segment or a combination of these conductive elements.

Here, the term “parallel” is understood to mean that the angle generated by the axial directions of each antenna is smaller than or equal to 30 degrees. In this case, the electromagnetic coupling between the two antennas is optimal, notably improving the communication performance of the passive radiofrequency transponder.

Here, the median plane of the coil and of the helical spring should first be defined. By definition, it is a fictional plane separating the object into two equal portions. In our case, this median plane is perpendicular to the axis of each antenna. Lastly, here the term “central region” is understood to mean that the relative distance between the median planes is smaller than one tenth of the length of the radiating antenna.

Thus, since the electrical current strength is of maximum magnitude at the centre of the radiating antenna, the magnetic field induced by this current is also maximum at the centre of the radiating antenna, and thus it is ensured that the inductive coupling between the two antennas is optimal, thereby improving the communication performance of the passive radiofrequency transponder.

By defining the relative dimensions of the primary antenna with respect to the characteristics of the helical spring of the radiating antenna, it is ensured that the distance between the two antennas will be smaller than the diameter of the primary antenna in the case where the primary antenna is located inside the radiating antenna. Thus, the electromagnetic coupling between the two antennas and therefore the communication performance of the radiofrequency transponder are optimized in transmission and in reception.

Likewise, outside of the region of the radiating antenna that is located plumb with the electronic portion and therefore with the primary antenna, a ratio of the helix pitch to the winding diameter higher than 0.8 for a loop of the radiating antenna has the effect of stretching the helical spring. Thus, the length of wire needed to cover a nominal distance of the radiating antenna is decreased. Thus, the resistance of the radiating antenna is decreased. Therefore, for a given electric field, the strength of the electrical current flowing through the radiating antenna is of higher magnitude at the natural frequency of the antenna, this allowing the communication performance of the radiofrequency transponder to be improved. In addition, stretching the helical spring allows the efficiency of the radiating antenna to be improved by improving the ratio between the radiation resistance and loss resistance thereof, this also allowing the electric field radiated by the radiating antenna for a given flow of electrical current through the radiating antenna to be maximized. Lastly, for the radiating antenna of given pitch, stretching the radiating antenna allows the volume occupied by the helical spring to be decreased. Thus, in a constrained dimensional environment, such as the thickness of a tyre casing, it is possible to increase the thickness of insulating rubber surrounding the radiating antenna in this first region. This electrical insulation minimizes losses and therefore improves the communication performance of the radiofrequency transponder, both in transmission and in reception. Of course, it is ideal for each of the loops of the first region of the radiating antenna to be elongated, this correspondingly improving the communication performance of the passive radiofrequency transponder, in particular when it is an RFID tag.

The term “situated plumb with two first threads” is understood to mean that the orthogonal projection of the element, in this case the radiating dipole antenna, onto the plane defined by two parallel first threads of the carcass reinforcement intersect these two first threads when the tyre casing is in the green tyre state.

Finally, the fact that the characteristic dimension of the radiating dipole antenna, which dimension is defined by the first longitudinal axis, is situated plumb with several first threads of the carcass reinforcement ensures that the passive radiofrequency transponder is in a controlled position in the thickness of the tyre casing, notably when it is in the green tyre state. Specifically, this configuration reduces the possible shifting of the radiating dipole antenna within the various non-crosslinked layers, notably with respect to the carcass reinforcement, when the tyre casing is being built up in the green state. Because the carcass reinforcement of the tyre casing runs from one bead wire to the other, that provides a wide region in which the passive radiofrequency transponder can be installed, and be operational, in the tyre casing. Specifically, the quantity of an elastomeric material surrounding the passive radiofrequency transponder is thus controlled, so that the length of the radiating dipole antenna can be tuned to the electrical environment of the radiating dipole antenna within the tyre reliably and robustly.

Finally, the radiofrequency transponder is situated in the bead and sidewall region of the tyre casing, notably between the spiral and the crown reinforcement of the crown block, so as to facilitate communication between it and an external radiofrequency reader notably in operation on the vehicle. Specifically, because the elements of the bodywork of the vehicle which are generally made of metal, such as the wheel or the wing hinder propagation of radioelectric waves to or from the passive radiofrequency transponder situated with the tyre casing, notably in the UHF frequency range, installing the passive radiofrequency transponder in the sidewall and bead region, radially on the outside of the spiral of the tyre casing makes it easier for the passive radiofrequency transponder to be interrogated and read by an external radiofrequency reader from a long distance in numerous positions of the external radiofrequency reader when the tyre casing is in service on a vehicle. The communications with the passive radiofrequency transponder are therefore robust and reliable. Although not essential for radiofrequency communication, the passive radiofrequency transponder is situated on the inside of the tyre casing. It is then incorporated into this casing during the manufacture of the tyre casing, thereby safeguarding the read-only data contained in the memory of the electronic chip of the passive radiofrequency transponder such as, for example, the tyre casing identifier. The alternative is to use techniques known in the prior art to affix a patch made from an elastomer compound containing said passive radiofrequency transponder to the external surfaces of the tyre casing such as, for example, to the layer of inner liner or to the sidewall. This operation may be performed at any moment during the course of the life of the tyre casing, making the tyre casing data contained in the memory of the electronic chip of the passive radiofrequency transponder less reliable.

Optionally, with the radiating dipole antenna comprising a second region in which the radiating dipole antenna is located plumb with the electronic portion, the ratio between the helix pitch P2 and the winding diameter D2 for each loop of the second region is lower than or equal to 0.8.

Specifically, in this second region of the radiating dipole antenna, and more particularly in the region located plumb with the primary antenna, the effect expected from the radiating dipole antenna is electromagnetic, and in particular inductive, coupling with the primary antenna of the electronic portion. Thus, a first lever for improving this coupling is to increase the inductance of the radiating antenna in this second region, this amounting to contracting the helical spring. In addition, contracting the radiating dipole antenna in this second region also promotes the transfer of energy between the primary antenna and the radiating dipole antenna by increasing, for a given length of the primary antenna located facing the radiating dipole antenna, the area of exchange furnished by the radiating dipole antenna. This improvement in energy transfer leads to a better communication performance being obtained from the passive radiofrequency transponder.

Preferably, the ratio between the helix pitch and the winding diameter of each of the loops of the helical spring in the first region of the radiating antenna is lower than 3, and preferably lower than 2.

Although it is advantageous to improve the radioelectric performance of the radiating antenna, it is necessary to also not neglect the other functions that it must perform. In particular, the helical spring is an extendable structure designed to withstand the three- dimensional stresses that the radiofrequency transponder in a tyre casing will have to face from the building of the tyre casing to the use of the tyre casing as an object of mobility on the vehicle. Thus, it is recommended to limit the amount by which the radiating antenna is stretched in this first region in order to ensure the radiating antenna preserves a sufficient suppleness on the whole and thus to ensure the physical integrity of the passive radiofrequency transponder.

Preferably, the primary antenna being connected to the terminals of a circuit board comprising the electronic chip, the electrical impedance of the primary antenna is matched to the electrical impedance of the circuit board of the radiofrequency transponder.

The term “electrical impedance of the circuit board” is understood to mean the electrical impedance across the terminals of the primary antenna, this representing the electrical impedance of the circuit board comprising at least one electronic chip and a printed circuit board to which the electronic chip is connected.

By matching the impedance of the primary antenna to that of the circuit board, the radiofrequency transponder is optimized at the communication frequency by improving the gain and achieving a circuit board of more selective form factor and narrower passband. Thus, the communication performance of the radiofrequency transponder is improved for a given amount of energy transmitted to the radiofrequency transponder. This in particular results in an increase in the read distance of the radiofrequency transponder for a given emitted radioelectric power. The impedance match of the primary antenna is obtained by adjusting at least one of the geometric features of the primary antenna, such as, for example, the diameter of the wire, the material of this wire and the length of the wire.

The impedance match of the primary antenna may also be obtained by adding an impedance-matching circuit made up of additional electronic components between the primary antenna and the electronic circuit, such as, for example, filters based on an inductor, capacitors and transmission lines.

The impedance match of the primary antenna may also be obtained by combining features of the primary antenna and features of an impedance-matching circuit.

According to one particular embodiment, the electronic chip and at least one portion of the primary antenna are embedded in a stiff and electrically insulating mass, such as, for example, high-temperature epoxy resin. This assembly forms the electronic portion of the radiofrequency transponder.

Thus, the electronic portion comprising at least one portion of the primary antenna and the electronic chip connected to the printed circuit board is stiffened, making the mechanical connections between the components thereof more reliable with respect to the thermomechanical stresses to which the tyre casing is subjected, both while it is being connected and while it is in use.

This also allows the electronic portion of the radiofrequency transponder to be manufactured independently of the radiating antenna or of the tyre casing. In particular, for example, using a micro-coil of a number of turns as primary antenna allows miniaturization of the electronic component comprising the primary antenna and the electronic chip to be envisaged.

According to another embodiment, the portion of the primary antenna not embedded in the stiff mass is coated with an electrically insulating material.

Thus, if the primary antenna is not entirely contained in the stiff and electrically insulating mass of the electronic portion, it is useful to insulate it via a coating made of an electrically insulating material, such as those employed for an insulating sheath of an electrical cable.

According to one specific embodiment, the tyre casing comprises a third layer of elastomer compound situated axially on the outside of the carcass reinforcement and axially on the inside of the first and/or second layer of elastomer compound.

Thus, this configuration of tyre casing provides a compromise in the performance of the bead and of the sidewall that are differentiating and the passive radiofrequency transponder can be inserted in contact with this third layer of elastomer compound.

According to another specific embodiment, with the tyre casing comprising an airtight layer of elastomer material, which is to say a layer that is highly impermeable to air, this layer being situated furthest towards the inside of the tyre casing with respect to the reference axis, the tyre casing comprises a fourth layer of elastomer compound situated on the inside of the carcass reinforcement.

This configuration of tyre casing makes it possible in particular to achieve extended running thanks to the fourth layer of elastomer compound situated in the sidewall of the tyre casing. In the event of the tyre casing losing inflation pressure, the fourth layer of elastomer compound is able to transmit load between the bead and the crown block without causing the sidewall of the tyre casing to buckle.

The passive radiofrequency transponder may therefore be in contact with this fourth layer of compound.

According to one particular embodiment, the tyre casing comprises third reinforcing threads positioned adjacently so as to constitute a reinforcing reinforcement.

These are special-purpose casings which, depending on the type of use or in-service stress loadings, require localized reinforcements in the bead for example in order to prevent rubbing between the wheel and the tyre casing. This reinforcing reinforcement may also be located in a certain region, particularly the axial ends of the crown block, to constrain the geometry of the crown block and of the tyre casing under severe thermomechanical stress loadings This reinforcing reinforcement generally has at least one free end. The passive radiofrequency transponder may then be in contact with or close to the free end of this reinforcing reinforcement.

According to one specific embodiment, the passive radiofrequency transponder is partially encapsulated in a mass of electrically insulating elastomer compound.

The term “electrically insulating” is understood here to mean that the electrical conductivity of the elastomer compound is at least below the conductive charge percolation threshold of the compound.

According to a final specific embodiment, the relative dielectric constant of the encapsulating mass is lower than 10.

This value of relative dielectric permittivity of the elastomer compounds that make up the encapsulating mass ensures the stability of the environment in which the passive radiofrequency transponder is situated, thus making the subject matter of the invention robust. Thus, the encapsulating mass assures the radioelectric waves of an environment that remains constant, thus robustly fixing the dimension of the radiating dipole antenna for operation at the target communication frequency.

According to another specific embodiment, the tensile elastic modulus of the encapsulating mass is lower than the tensile elastic modulus of at least one elastomer compound adjacent to said encapsulating mass.

This then forms an assembly that makes the passive radiofrequency transponder easier to fit into the green tyre casing while restricting the mechanical singularity that the passive radiofrequency transponder constitutes within the tyre casing. A conventional bonding-rubber layer will possibly be employed, if necessary, to secure this assembly to the tyre casing.

In addition, the stiffness and electrical-conductivity characteristics of the elastomer compound ensure a quality mechanical insertion and electrical insulation of the passive radiofrequency transponder within the tyre casing. Thus, the operation of the radiofrequency transponder is not perturbed by the tyre casing.

According to a first preferred embodiment, the passive radiofrequency transponder is situated in contact with a layer of elastomer compound of the tyre casing.

This is an embodiment which makes the passive radiofrequency transponder easier to fit into the architecture of the tyre casing. The fitting of the passive radiofrequency transponder takes place directly in the means for building the green tyre by said passive radiofrequency transponder being placed onto the elastomer compound. The passive radiofrequency transponder will then be covered with a second layer of elastomer compound. In this way, the passive radiofrequency transponder is therefore fully encapsulated by the components of the tyre casing. It is therefore embedded within the tyre casing, ensuring that it cannot be falsified when the memory of the electronic chip is write protected. The alternative is to position the passive radiofrequency transponder directly on the threads, although this may prove troublesome if the threads are made of metal. It would be preferable, if direct placement on the threads is still adopted, for the passive radiofrequency transponder to be coated beforehand in a mass of electrically insulating elastomer compound. As a preference, the assembly will be covered with another layer of elastomer compound. In that way, the passive radiofrequency transponder will still be in contact with a layer of elastomer compound.

As a preference, the passive radiofrequency transponder is situated at a distance of at least 5 millimetres from the ends of a reinforcing reinforcement of the tyre casing.

The passive radiofrequency transponder presents as a foreign body in the build of the tyre, constituting a mechanical singularity. The ends of the reinforcements also constitute mechanical singularities. To safeguard the endurance of the tyre casing, it is preferential for the two singularities to be distanced from one another by a certain distance. The greater this distance, the better, the minimum distance of the influence of a singularity being of course proportional to the size and nature of this singularity. The singularity formed by the end of a reinforcing reinforcement becomes more sensitive the greater the stiffness of the adjacent elastomer compounds in comparison with the stiffness of the reinforcing reinforcement. When the reinforcers are metallic or made of a textile that has just as high a stiffness, such as in the case of aramid, for example, it is appropriate to keep the two singularities at least 10 millimetres apart from one another.

Highly preferably, with the orientation of the first threads defining a direction of reinforcement, the first longitudinal axis of the radiating dipole antenna is perpendicular to the direction of reinforcement.

This is a particular embodiment that allows better distribution of the load passing between the passive radiofrequency transponder and the tyre casing during manufacture of the tyre casing or during use of the tyre casing. In addition, this orientation is very well determined during the manufacture of the tyre casing because this direction acts as a guide for the manufacture of the tyre casing, making it easier to install the passive radiofrequency transponder in the green form of the tyre casing.

According to one specific embodiment, the radioelectric communication with the radiofrequency reader occurs in the UHF band and most specifically in the range comprised between 860 and 960 MHz.

Specifically, in this frequency band, the length of the radiating antenna is inversely proportional to the communication frequency. Furthermore, outside of this frequency band, radioelectric communication is highly perturbed or even impossible through standard elastomeric materials. Thus, this is the best compromise between the size of the radiofrequency transponder and its radioelectric communication, in particular in the far-field, making it possible to have communication distances that are satisfactory for the field of tyres.

According to another particular embodiment, the length L0 of the radiating antenna is comprised between 30 and 50 millimetres.

Specifically, in the frequency range between 860 and 960 MHz and depending on the relative dielectric permittivities of the elastomer compounds surrounding the radiofrequency transponder, the total length of the helical spring, which is tailored to the half-wavelength of the radioelectric waves transmitted or received by the radiofrequency transponder, is located in the interval between 30 and 50 millimetres, and preferably between 35 and 45 millimetres. In order to optimize the operation of the radiating antenna at these wavelengths, it is recommended to perfectly tailor the length of the radiating antenna to the wavelength.

Advantageously, the winding diameter of the helical spring in the first region of the radiating antenna is comprised between 0.6 and 2.0 millimetres, and preferably between 0.6 and 1.6 millimetres.

This allows the volume occupied by the radiating antenna to be limited and therefore the thickness of electrically insulating elastomer compound around the radiofrequency transponder to be increased. Of course, this diameter of the helical spring in the first region of the radiating antenna may be constant, variable, continually variable or piecewise variable. It is preferable from a point of view of the mechanical integrity of the radiating antenna for the diameter to be constant or continuously variable.

According to one preferred embodiment, the helix pitch of at least one loop of the radiating antenna in the first region of the radiating antenna is comprised between 1 and 4 millimetres, and preferably between 1.3 and 2 millimetres.

This makes it possible to ensure that the ratio of the helix pitch to the winding diameter of the spring, or at least one loop, in the first region of the radiating antenna is lower than 3, guaranteeing a minimum of elongation of the helical spring. In addition, this pitch may also be constant or variable throughout the first region of the radiating antenna. Of course, it is preferable for the pitch to be continuously variable or variable with small transitions in variation in order to avoid singular points in the radiating antenna that would form mechanical weaknesses in the radiating antenna.

According to one advantageous embodiment, the diameter of the wire of the radiating antenna is comprised between 0.05 and 0.25 millimetres, and ideally between 0.12 and 0.23 millimetres.

In this wire range, loss resistance is certain to be low, thus improving the radioelectric performance of the radiating antenna. In addition, limiting the diameter of the wire allows the distance between the radiating antenna and the electrical conductors to be increased by increasing the thickness of the electrically insulating elastomer compounds. However, it is necessary for the wire to preserve a certain mechanical strength in order to be able to bear the thermomechanical stresses that it will undergo in a highly stressed environment such as a tyre casing, without optimizing the breaking stress of the material of these wires, which is generally mild steel. This makes it possible to ensure the radiating antenna represents a satisfactory technical/economical compromise.

Advantageously, the first pitch P1 of the radiating dipole antenna, which corresponds to the helix pitch of the radiating dipole antenna in the first region is greater than the second pitch P2 of the radiating dipole antenna which corresponds to the helix pitch of the radiating dipole antenna in the second region in which the radiating dipole antenna is situated plumb with the electronic portion.

By requiring that the helix pitch P2 of the radiating dipole antenna in a second region in which the radiating dipole antenna is located plumb with the electronic portion be smaller than the pitch P1 of the radiating dipole antenna outside this region, the electromagnetic aptitudes of the radiating dipole antenna in this region are favoured to the detriment of its radiating efficacy, which are promoted in the first region of the radiating dipole antenna. Thus, the compression of the helix pitch of the radiating dipole antenna improves the inductance of the antenna in this region. For a given flow of electrical current through the radiating dipole antenna, this is a lever arm that is essential to increase the magnetic field generated by the antenna. Furthermore, this improvement in the inductance of the radiating dipole antenna is obtained without necessarily modifying the winding diameter of the radiating antenna. In addition, for a primary antenna of given length, the compression of the pitch of the radiating dipole antenna plumb with the primary antenna of the electronic portion ensures a larger area of exchange between the two antennas, thus also improving the electromagnetic coupling between the two antennas. Thus, the communication performance of the radiofrequency transponder is thereby improved. Lastly, the compression of the pitch of the radiating dipole antenna allows the manufacturing tolerances on the radiating dipole antenna to be minimized and better controlled in this second region, in particular as regards the definition of the winding diameter of the radiating dipole antenna. Thus, the scrap rate for the radiating dipole antennas is reduced since it is the control over this diameter that governs the positioning of the electronic portion with respect to the radiating dipole antenna.

Highly advantageously, with the electronic portion being placed inside the radiating antenna, the first inside diameter D1′ of the radiating dipole antenna in the first region is smaller than the second inside diameter D2′ of the radiating dipole antenna in a second region, and the electronic portion is circumscribed by a cylinder of which the axis of revolution is parallel to the first longitudinal axis and of which the diameter is larger than or equal to the first inside diameter D1′ of the radiating dipole antenna.

By ensuring that the cylinder that circumscribes the electronic portion has an axis of revolution parallel to the first longitudinal axis and a diameter larger than or equal to the first inside diameter of the radiating dipole antenna, the first region of the radiating antenna therefore forms a stop with respect to the axial movement of the electronic portion. The fact that this first region is situated on each side of that region of the radiating dipole antenna that is situated plumb with the electronic portion because of the centred positioning of the electronic portion with respect to the radiating dipole antenna, ensures that there are therefore two mechanical end stops situated axially on the outside of the electronic portion and limiting any axial movement of the electronic portion of the radiofrequency transponder. In addition, because the diameter of the cylinder circumscribing the electronic portion is situated on the inside of the radiating antenna in the second region, this diameter has to be smaller than the second inside diameter of the radiating antenna. Thus, any radial shifting of the electronic portion is confined by the second inside diameter of the radiating dipole antenna. In conclusion, the movement of the electronic portion is limited, this allowing the communication performance of the radiofrequency transponder to be ensured while ensuring a physical integrity of the electronic portion and of the radiating dipole antenna of the passive radiofrequency transponder. Lastly, the endurance of the tyre casing accommodating this radiofrequency transponder is also not impacted by this choice of design. Furthermore, the radiofrequency transponders are made easier to handle for fitting into the structure of the tyre casing without the need to take additional precautions.

### BRIEF DESCRIPTION OF THE DRAWINGS

The invention will be better understood by means of the following detailed description. These applications are given solely by way of example and with reference to the appended figures, throughout which the same reference numerals denote identical parts, and in which:

FIG. 1 shows a perspective view of a radiofrequency transponder of the prior art;

FIG. 2 shows a perspective view of a radiofrequency transponder according to the invention;

FIGS. 3a and 3b are illustrations of the length of the wire of the radiating antenna depending on the ratio between the helix pitch and the winding diameter of the helical spring for a given elementary length of the radiating dipole antenna and depending on whether a constant pitch or constant winding diameter is employed;

FIG. 4 is one example of a radiofrequency transponder according to the invention, having certain particularities;

FIG. 5 is an exploded view of an identification tag according to the invention;

FIG. 6 shows a graph of the electrical power transmitted to two passive radiofrequency transponders incorporated into a tyre casing according to the invention, as a function of the observation frequency band;

FIG. 7 shows a view in meridian section of a tyre casing of the prior art;

FIG. 8 is a view in meridian section of the bead and of the sidewall of a tyre casing according to the invention when the passive radiofrequency transponder is located in the outer region of the tyre casing;

FIG. 9 is a view in meridian section of the bead and of the sidewall of a tyre casing according to the invention when the passive radiofrequency transponder is located in the inner region of the tyre casing;

FIG. 10 is a view in meridian section of a tyre casing comprising passive radiofrequency transponders in the upper part of the sidewall.

### DETAILED DESCRIPTION OF EMBODIMENTS

Below, the terms “tyre” and “pneumatic tyre” are employed equivalently and refer to any type of pneumatic or non-pneumatic tyre.

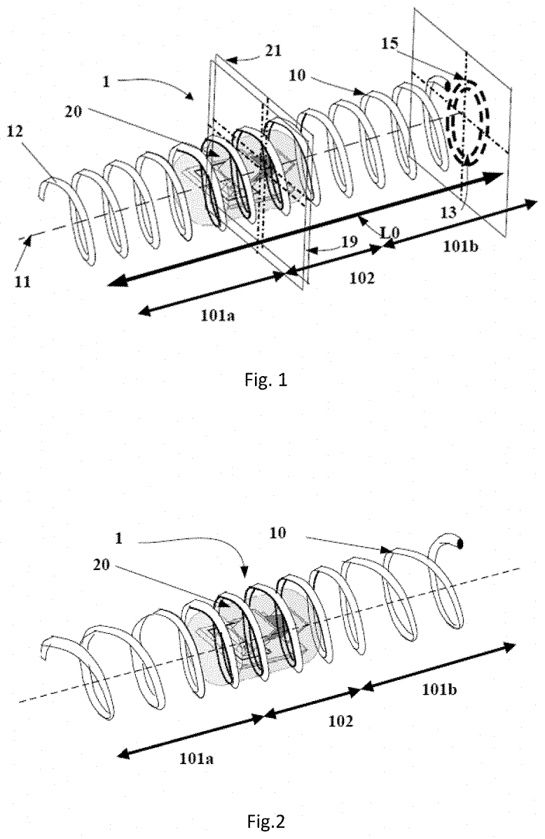

FIG. 1 shows a prior-art radiofrequency transponder 1 in a configuration in which the electronic portion 20 is located inside the radiating antenna 10. The radiating antenna 10 consists of a steel wire 12 that has been plastically deformed in order to form a helical spring having an axis of revolution 11. The helical spring is defined primarily by a winding diameter of the coated wire and a helix pitch. These two geometric parameters of the helical spring are constant here. Thus, inside 13 and outside 15 diameters of the helical spring are precisely determined taking the diameter of the wire into account. The length L0 of the spring corresponds here to one half-wavelength of the radiofrequency transmission signal of the transponder 1 in a mass of elastomer compound. It is thus possible to define a median plane 19 of the helical spring perpendicular to the axis of revolution 11 separating the radiating antenna 10 into two equal parts. The geometric shape of the electronic portion 20 is circumscribed in a cylinder, the diameter of which is smaller than or equal to the inside diameter 13 of the helical spring. This makes it easier for the electronic portion 20 to be inserted into the radiating antenna 10. The median plane 21 of the primary antenna is located substantially superposed with the median plane 19 of the radiating antenna 10. Lastly, the axis of the primary antenna is substantially parallel to the axis of revolution 11 of the radiating antenna 10. The radiating antenna may be divided into two distinct regions: a first region 101 of the radiating antenna 10, in which the helical spring is not situated plumb with the electronic portion 20, and a second region 102 situated plumb with the electronic portion 20. The first region 101 of the radiating antenna 10 comprises two portions 101a and 101b of substantially equivalent lengths, these portions axially flanking the second region 102 of the radiating antenna 10.

FIG. 2 is a radiofrequency transponder 1 according to the invention, which has, with respect to the prior-art radiofrequency transponder, the distinctive feature that the ratio of the helix pitch to the winding diameter of at least one loop of the radiating antenna of the first region is higher than 0.8. In our case, all the loops of each of the regions 101a and 101b have had their ratio changed equivalently. This is achieved by decreasing the total number of loops in each of the sub-regions 101a and 101b. In this particular case, the winding diameter for the winding of the wire of the radiating antenna 10 is kept the same. However, it would also have been possible to modify the ratio of the helix pitch to the winding diameter of each loop of the first region 101 by increasing the winding diameter for the winding of the steel wire of the radiating antenna 10 in the first region 101 of this antenna. In our case, the helix pitch of the radiating antenna 10 in the second region 102 of the radiating antenna 10 has not been modified. Thus, the ratio between the helix pitch and the winding diameter in the second region 102 of the radiating antenna 10 is lower than 0.8.

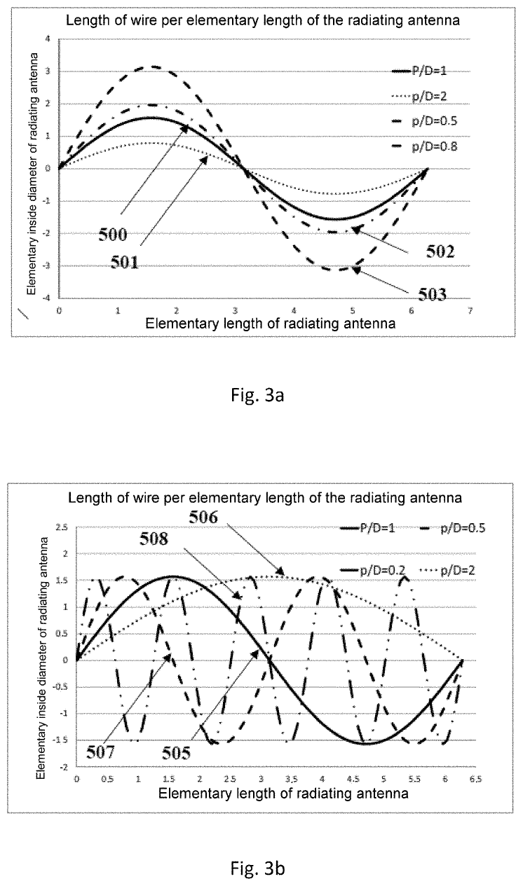

FIGS. 3a and 3b are illustrations of the importance, with respect to the radioelectric and electromagnetic properties of the radiating antenna, of the ratio of the helix pitch to the winding diameter, for one loop of the helical spring.

FIG. 3a is an illustration of variations in the ratio of the helix pitch to the winding diameter of a loop when the helix pitch of the loop and the diameter of the wire from which the loop is formed remain constant. For an elementary length of the radiating antenna of length equal to the region occupied by a complete loop for a ratio equal to 1, the curvilinear distance of this loop is equal to 2 *PI*PI elementary units. The curve 500 drawn with a solid line corresponds to this loop. Specifically, the radius of this loop is necessarily equal to PI elementary units. Considering now the curve 501 drawn in dotted line which corresponds to a ratio equal to 2, because the helix pitch is constant, the winding diameter of this loop must be a factor of two times smaller than the winding diameter of the previous loop, namely PI elementary units. Thus, the curvilinear distance of this loop illustrated by the dotted line 501 is equal to PI*PI elementary units. Therefore, the curvilinear length of a first loop, having a higher ratio of helix pitch to winding diameter than a second loop, is smaller than the curvilinear length of this second loop. The curve 502 drawn with the dashed line and the curve 503 drawn with the dash-dot line illustrate ratios of 0.8 and of 0.5, respectively. The curvilinear lengths of these two loops are equal to 2.5*PI*PI elementary units and 4*PI*PI elementary units, respectively.

FIG. 3b is an illustration of the variations in the ratio of the helix pitch to the winding diameter of a loop when the diameter of the loop and the diameter of the wire from which the loop is formed remain constant. For an elementary length of the radiating antenna of length equal to the region occupied by a complete loop for a ratio equal to 1, the curvilinear distance of this loop is equal to 2 *PI*PI elementary units. The curve 505 drawn with a solid line corresponds to this loop. Specifically, the radius of this loop is necessarily equal to PI elementary units. Considering now the curve 506 which corresponds to a ratio equal to 2, because the winding diameter is constant, the helix pitch of this loop must be a factor of two times larger than the helix pitch of the previous loop, namely 4*PI elementary units. However, if the elementary length is limited to 2*PI elementary units, the curvilinear distance of this loop illustrated in dotted line is equal to PI*PI elementary units. Likewise, for curves 507 and 508 which correspond to ratios of 0.5 and 0.2 respectively, i.e. a doubling and a fivefold increase in the number of loops respectively, the curvilinear distance of the curve 507 illustrated in dotted line is equal to 4*PI*PI elementary units. Furthermore, the curvilinear distance of the curve 508 drawn in dash-dot-dot line is equal to 10*PI*PI elementary units.

Of course, instead of solely modifying the helix pitch or the winding diameter of each loop, it is possible to modify both parameters simultaneously. Only the ratio obtained via these two modifications will have an impact on the communication performance of the radiating antenna.

Specifically, the resistance of a conductive wire is proportional to the curvilinear length of the wire. The higher the ratio of the helix pitch to the winding diameter of the loop, the shorter the curvilinear length of the wire. Thus, the lower the electrical resistance of the loop. In conclusion, the radioelectric properties of the loops of the radiating antenna are improved by minimizing this electrical resistance. By minimizing the electrical resistance of the radiating antenna in the first region of the radiating antenna, the radiation efficiency of the antenna is improved both in transmission and in reception, the antenna mainly consisting of this first region. In addition, minimizing the electrical resistance of the antenna ensures a maximum electrical current is generated for a given electrical potential difference. Thus, the radioelectric performance and therefore the communication performance of the radiofrequency transponder are thereby improved.

In the second region of the radiating antenna, the radiation efficiency of this second region, which is smaller than the first region, is not essential. Specifically, the main function of this second region is to ensure electromagnetic coupling to the primary antenna of the electronic portion. This electromagnetic coupling is mainly due to inductive coupling if the primary antenna is a coil of a number of turns. For this coupling to occur, the radiating antenna must first generate a magnetic field. This magnetic field is in particular dependent on the inductance of the radiating antenna. To maximize the inductance of a coil, it is recommended to decrease the ratio of the helix pitch to the winding diameter of the coil or to increase the number of loops of the coil. By decreasing the ratio of the helix pitch to the winding diameter of the loops of the second region of the radiating antenna, the inductive coupling is maximized by increasing the inductance of the antenna. In addition, if this ratio is decreased by modifying only the helix pitch of the antenna, the number of turns making up the second region of the antenna is increased, this increasing the area of energy transfer between the two antennas. This increase in the area of energy transfer is of course favourable to the communication performance of the radiofrequency transponder.

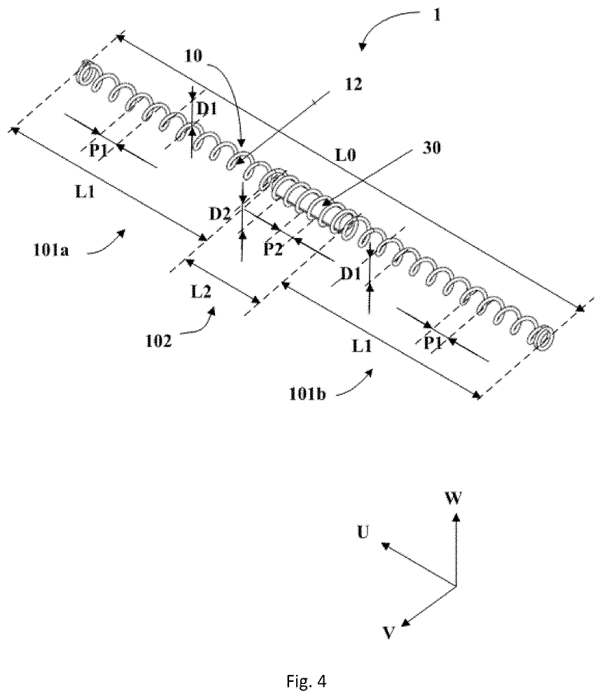

FIG. 4 is an illustration of a radiofrequency transponder 1 operating in the frequency range between 860 and 960 MHz and intended to be incorporated into a tyre casing. To improve the radiocommunication performance and the physical integrity of the radiofrequency transponder 1 within a tyre casing having a bead wire, without thereby impairing the endurance of the tyre casing, it will be preferable to arrange the axis of revolution of the radiating antenna 10 parallel to the axis U so that it rests on at least two reinforcing threads of the carcass ply of the tyre casing. In particular, and optionally, the axis of revolution of the radiating antenna 10 will be perpendicular to the direction of reinforcement defined by the reinforcing threads of the carcass reinforcement so that the mechanical anchor points for the passive radiofrequency transponder can be multiplied particularly if this transponder is incorporated during the course of manufacture of the tyre casing. As a result, the passive radiofrequency transponder 1 will be positioned circumferentially with respect to the reference axis of revolution of the tyre casing.

In addition, the radiofrequency transponder will be positioned axially on the outside with respect to the end axially internally of the bead. This is region that is mechanically stable as it does not experience sizeable unforeseen variations in thermomechanical deformation. Finally, the passive radiofrequency transponder 1 will be placed radially between the radially upper end of the spirals and the axial end of the crown block of the tyre casing. This positioning in the radial direction makes it easier for the passive radiofrequency transponder incorporated into a tyre casing of a land vehicle to communicate with a radiofrequency reader situated outside the land vehicle as there are few conducting elements interposed between the radiofrequency reader and the passive radiofrequency transponder 1.

The radiofrequency transponder 1 here comprises a radiating antenna 10 and an electronic portion located inside the radiating antenna 10. The electronic portion comprises an electronic chip connected to a printed circuit board and a primary antenna consisting of a conducting wire comprising seventeen rectangular turns connected to the printed circuit board. The face of the printed circuit board opposite to the primary antenna comprises a galvanic circuit of meander shape forming a line of 10 millimetres length and of 1 millimetre width. Lastly, the diameter of the cylinder circumscribing the primary antenna is 0.8 millimetres.

The circuit board thus formed is embedded in a mass 30 of epoxy resin, ensuring the mechanical reliability of the electronic components and the electrical insulation of the circuit board. The cylinder circumscribing the stiff mass 30 has a diameter of 1.15 millimetres and a length of 6 millimetres.

The length L0 of the radiating antenna 10 is here 45 millimetres and corresponds to one half-wavelength of radioelectric waves at a frequency of 915 MHz in a medium of relative dielectric permittivity of about equal to 5. The radiating antenna 10 is produced using a steel wire 12 of 0.225 millimetre diameter the surface of which is coated with a layer of brass.

The radiating antenna 10 may be divided into two main regions. The first region 101 corresponds to the section of the radiating antenna that is not located plumb with the electronic portion. It comprises two sub-regions 101a and 101b flanking on either side the stiff and insulating mass 30.

Each sub-region 101a, 101b has a length L1 of 19 millimetres and comprises 12 circular turns of a constant winding diameter D1 of 1.275 millimetres. This defines inside and outside diameters of 1.05 and 1.5 millimetres, respectively. The helix pitch P1 of the circular turns is of 1.55 millimetres. Thus, the ratio of the helix pitch P1 to the winding diameter D1 of the turns is 1.21. The axially outer ends of each sub-region 101a and 101b ends in 2 adjoined turns. Thus, the high ratio ensures the efficacy of the radioelectric properties of the radiating antenna 10 is maximized in this region 101. In addition, the contact between the turns located outermost on the radiating antenna 10 prevents the helical springs from becoming interlaced with one another during handling of the radiofrequency transponders. As most of the turns of the first region 101 of the radiating antenna 10 have a ratio higher than 0.8, the radioelectric performance of the radiofrequency transponder 1 is clearly improved.

In the second region 102 of the radiating antenna 10, which corresponds to the section of the radiating antenna 10 located plumb with the electronic portion, the radiating antenna has a length of 7 millimetres. The helical spring has a constant helix pitch P2 of 1 millimetre and a constant winding diameter D2 of 1.575 millimetres. Thus, the inside diameter of the helical spring of the second region of the radiating antenna is 1.35 millimetres. This makes it possible to have a ratio of the helix pitch to the winding diameter that is constant of the order of 0.63. This ratio allows the inductance of the second region 102 of the radiating antenna 10 to be maximized with respect to the first region 101, this allowing the efficacy of the electromagnetic coupling to the electronic portion to be improved.

In this particular case, in the first region 101 the inside diameter of the radiating antenna 10, which is equal to 1.05 millimetres, is smaller than the diameter, equal to 1.15 millimetres, of the mass 30 as represented by the cylinder circumscribing the electronic portion. Thus, the sub-regions 101a and 101b of the first region 101 of the radiating antenna 10 form mechanical stops that limit the axial movement of the mass 30 inside the radiating antenna 10. The electronic portion is installed by inserting the stiff and insulating mass 30 into the radiating antenna 10.

In addition, the diameter of the cylinder circumscribing the primary antenna is much larger than one third of the inside diameter of the helical spring of the second region 102 of the radiating antenna. Although the cylinder circumscribing the primary antenna is not coaxial with the axis of revolution U of the radiating antenna 10, it is substantially parallel thereto. Furthermore, the minimum distance between the second region 102 of the radiating antenna 10 and the primary antenna is smaller than 0.3 millimetres, i.e. much smaller than one quarter of the inside diameter of the radiating antenna 10. This proximity of the antennas is permitted by the compressed pitch P2 applied in the second region 102 of the radiating antenna 10, which allows a lower tolerance to be obtained for the dimensions of the spring and in particular for the winding diameter D2. In addition, this proximity ensures better quality electromagnetic coupling between the two antennas. Of course, this electromagnetic coupling could have been improved by using turns of identical shape in the primary antenna and in the radiating antenna, such as circular turns for example. This coupling could also have been optimized by making the axes of the two antennas coaxial, this amounting to placing the circuit board inside the primary antenna in such a way as to minimize the axial dimension of the electronic portion. Thus, the quality of the area of transfer of electromagnetic energy between the two antennas would have been optimal.

Other specific embodiments, in particular in the case of variation of the winding diameter of the helical spring between the first and second regions of the radiating antenna, particularly in instances in which the inside diameter of the first region of the radiating antenna is smaller than the diameter of the cylinder circumscribing the electronic portion, may be employed.

FIG. 5 shows an identification tag 2 comprising a radiofrequency transponder 1 according to the invention embedded in a supple mass 3 made of electrically insulating elastomeric material, this mass being made up of the blocks 3a and 3b. The radiofrequency transponder 1 is generally placed in the middle of the tag 2 in order to maximize the smallest distance between the first region 101 of the radiating antenna 10 and the external surface of the identification tag 2.

In the case where the ratio between the helix pitch and the winding diameter of the loop of the first region 101 of the radiating antenna 10 is increased by decreasing the winding diameter of the steel wire, the volume occupied by the radiofrequency transponder 1 within the mass 3 of elastomeric material is decreased.

This allows, in a first application, the thickness of each of the blocks 3a and 3b of the identification tag 2 to be decreased while keeping the same distance between the external surface of the identification tag 2 and the first region 101 of the radiating antenna 10. This decrease in the thickness of the identification tag 2 will facilitate its introduction into an object to be identified, while preserving the same electrical-insulation potential. In a second application, this allows the distance between the first region 101 of the radiating antenna 10 and the external surface of the identification tag 2 to be increased. This second application allows radioelectric performance to be improved and therefore the communication performance of the radiofrequency transponder 1 placed in the identification tag 2. Specifically, the electrical insulation of the tag 2 is proportional to the distance between the first region 101 of the radiating antenna 10 and the external surface of the tag 2. The radioelectric operation of the radiofrequency transponder 1 is improved, or stays the same if this distance has reached its efficacy asymptote, by a better electrical insulation of the identification tag 2.

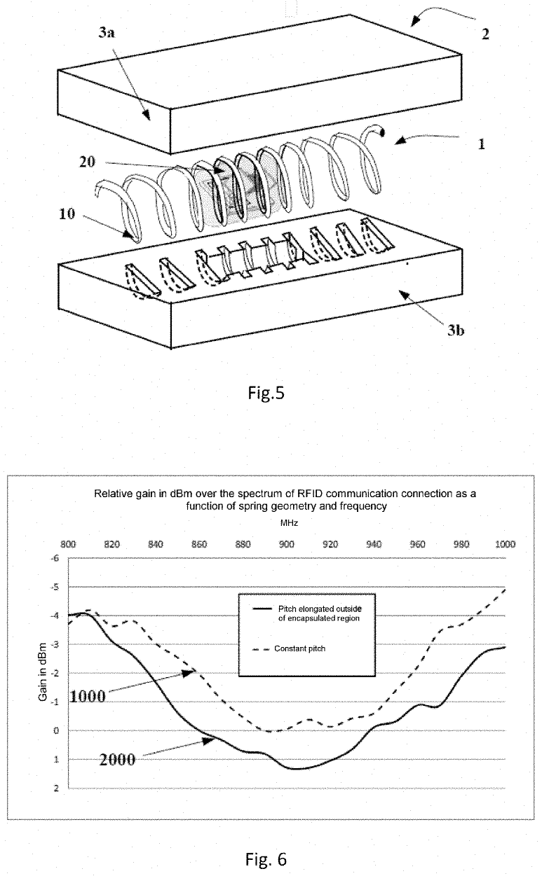

FIG. 6 is a graph of the electrical power transmitted by passive radiofrequency transponders, each located inside a Pilot Sport 4S Michelin tyre casing of 235/30 ZR20 dimension to an external radiofrequency reader. The passive radiofrequency transponders are situated in the bead region, radially on the outside of the radially upper end of the spiral at a distance of 40 millimetres and bearing radially against the first layer of elastomer compound. The communication frequency of the radiofrequency transponders is centred on 915 MHz. The measurement protocol employed corresponds to that of standard ISO/IEC 18046-3 entitled “Identification Electromagnetic Field Threshold and Frequency Peaks”. Measurements were carried out at a wide range of scanned frequencies and not at a single frequency as conventionally is the case. The x-axis represents the frequency of the communication signal. The y-axis represents the electrical power received by the radiofrequency reader expressed in decibels relative to the maximum electrical power transmitted by a current state-of-the-art radiofrequency transponder. The dashed curve 1000 represents the response of a radiofrequency transponder according to the cited document. The continuous curve 2000 represents the response of a transponder according to the invention to the same signal transmitted by the radiofrequency reader. An improvement of about two decibels in favour of the radiofrequency transponder according to the invention at the communication frequency of the radiofrequency reader will be noted. The improvement remains of the order of at least one decibel over a wide frequency band about the communication frequency.

The circumferential direction of the tyre, or longitudinal direction, is the direction that corresponds to the periphery of the tyre and is defined by the direction of running of the tyre casing.

The transverse or axial direction of the tyre is parallel to the axis of rotation, or reference axis, of the tyre casing.

The radial direction is a direction which crosses the reference axis of the tyre casing and is perpendicular thereto.

The axis of rotation or reference axis of the tyre casing is the axis about which it turns in normal use.

A radial or meridian plane is a plane that contains the reference axis of revolution of the tyre.

The circumferential median plane, or equatorial plane, is a plane that is perpendicular to the reference axis of the tyre casing and divides the latter into two halves.

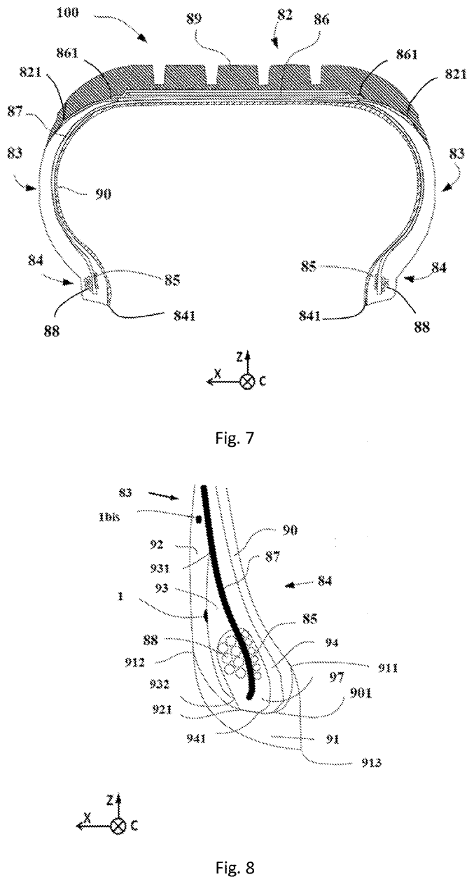

FIG. 7 shows a meridian section of a tyre casing 100 including a crown 82 reinforced by a crown reinforcement or belt 86, two sidewalls 83 and two beads 84. The crown 82 is delimited axially by two axial ends 821 providing the connection with each sidewall 83 of the tyre casing 100. The crown reinforcement 86 extends axially as far as an axial end 861 at each of its edges. The crown reinforcement 86 is surmounted radially on the outside by a tread 89 made of an elastomeric material. A carcass reinforcement 87 anchored in the beads 84 separates the tyre casing into two regions, which will be called inner region, in the direction of the fluid cavity, and outer region, towards the outside of the wheel-tyre assembly. Each of these beads 84 is reinforced with a first spiral 85 situated in the interior region of the tyre casing and, in this example, by a second spiral 88 situated in the outer region of the tyre casing. The bead 84 has a radially and axially interior end 841. The carcass reinforcement 87 comprises reinforcing threads forming outward and return portions between the ends of the carcass, said ends being sandwiched between the two spirals 85 and 88 in each bead 84. The carcass reinforcement 87 is, in a manner known per se, made up of textile threads. The carcass reinforcement 87 extends from one bead 84 to the other so as to form an angle of between 80° and 90° with the circumferential median plane EP. An airtight inner liner layer 90 extends from one bead 84 to the other, and is situated internally with respect to the carcass reinforcement 87.

FIG. 8 shows a detailed view of the tyre casing 100 in the region of the bead 84 and the sidewall 83. This figure illustrates the positioning of the passive radiofrequency transponder 1 in the exterior region of the tyre casing 100 with respect to the carcass reinforcement 87.

The bead 84 is made up of the spirals 85 and 88 situated respectively in the inner and outer region of the tyre casing, sandwiching the ends of the carcass reinforcement 87, all coated in a layer of elastomer compound 97. A first layer 91 of rubber compound, referred to as bead protector is situated radially on the inside of the spirals 85 and 88. It has a radially and axially exterior free edge 912. It also has two free edges 911 and 913 that are axially on the inside with respect to the carcass reinforcement 87. The radially innermost free edge 913 here constitutes the interior end of the bead 84. A second layer of elastomer compound 92 situated radially on the outside of the first layer of elastomer compound 91 defines the exterior surface of the sidewall 83. A third layer of rubber compound 93, referred to as the “reinforcing filler” is adjacent to the second layer of elastomer compound 92. It has two free edges. The first free edge 932 is situated radially on the inside and bears against the layer of elastomer compound 97. The other free edge 931 is situated radially on the outside and ends on the face of the carcass reinforcement 87.

The airtight inner liner 90, which is axially on the inside of the carcass reinforcement 87 in this configuration, is located on the inner region of the tyre casing 100. It ends with a free edge 901 adjacent to the layer of elastomer compound 97. Finally, a fourth layer of elastomer compound 94 protects the carcass reinforcement

The bead 84 and the sidewall 83 of this tyre casing 100 are equipped with passive radiofrequency transponders, numbered 1, possibly with suffixes, which are situated in the exterior region of the tyre casing 100. The first passive radiofrequency transponder 1, having been encapsulated beforehand in an electrically insulating encapsulating rubber, is positioned on the outer face of the third layer of elastomer compound 93. It is positioned at a distance of 10 millimetres from the radially outer free edge of the spiral 88 that constitutes a mechanical singularity. This position ensures a region of mechanical stability for the radiofrequency transponder 1 that is beneficial to the mechanical endurance thereof In addition, embedding it within the very structure of the tyre casing 100 gives it good protection from mechanical attacks coming from outside the tyre casing 100.

The second radiofrequency transponder ibis, having optionally been encapsulated in an electrically insulating encapsulating rubber compatible with the material of the second layer of elastomer compound 92 or of similar composition, is positioned on the inside of the second layer of elastomer compound 92. The material similarity between the second layer of elastomer compound 92 and the encapsulating rubber ensures that the radiofrequency transponder ibis is installed inside the sidewall 83 during the curing process. The radiofrequency transponder ibis is simply placed within the material during the injection of the second layer of raw elastomer compound 92 during the building of the tyre casing 10. The pressurizing of the green tyre in the curing mould ensures that the radiofrequency transponder ibis is, in the cured state, positioned as shown. This radiofrequency transponder ibis is situated far from any free edge of any other constituent of the tyre casing 100. In particular, it is spaced from the free edge 931 of the third layer of elastomer compound 93, from the radially outer free edge of the spiral 88 and from the free edges 912 of the bead protector 91. Its positioning ensures improved communication performance with an external radiofrequency reader by distancing it from the metallic components of the wheel-tyre assembly. Cyclic stress loadings during running will not be disruptive due to the mechanical decoupling between the radiating antenna and the electronic portion of the passive radiofrequency transponder ibis. Of necessity, these two transponders are situated axially on the outside of the end 913 of the first layer of rubber compound 91 and therefore of the inner end of the bead 84. They are positioned radially between the radially outer end of the spiral 88 with respect to the reference axis of the tyre casing 100, and the axial ends 861 of the crown reinforcement 86.

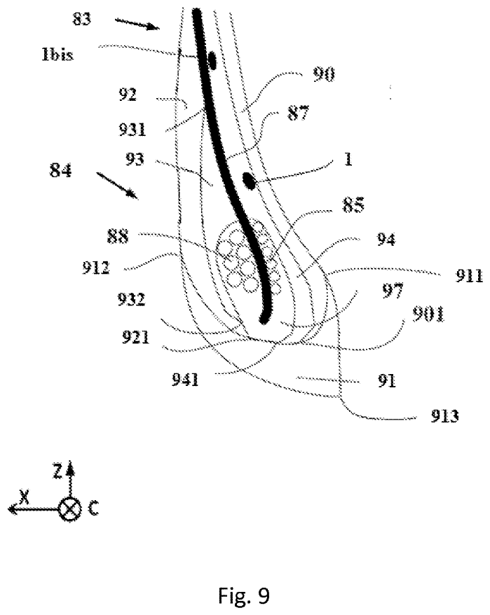

FIG. 9 shows a detailed meridian section of a tyre casing 100 in the region of the bead 84 and of the sidewall 83. This FIG. 9 illustrates the position of the passive radiofrequency transponder in the inner region of the tyre casing 100 with respect to the main part of the carcass reinforcement 87.

The tyre casing 100 comprises, in particular at the inner region, an airtight inner liner 90 and a layer of elastomer compound 94 interposed between the carcass reinforcement 87 and the airtight inner liner 90. This layer of elastomer compound 94 has a radially interior free edge 941 located under the spiral 85. This layer of elastomer compound 94 extending from one bead 84 to the other bead 84 of the tyre casing 100.

The location of the radiofrequency transponder ibis at the level of the first threads forming the carcass reinforcement 87 allows the radiofrequency transponder 1 to be mechanically stabilized. It is more than 40 millimetres radially outside the free edge 913 of the bead protector 91, which means it can be situated radially on the outside of the rim flange when the tyre casing is in operation, mounted on a wheel. By contrast, in order to ensure suitable radiocommunication performance, it is preferable to use an encapsulating rubber that is electrically insulating for encapsulating the radiofrequency transponder ibis. From a radiofrequency performance standpoint, this positioning provides better radiocommunication performance by being situated radially further toward the outside in the tyre casing 100. It can be oriented in any way provided that it rests on at least two first threads of the carcass reinforcement 87. That ensures axial positioning of the radiofrequency transponder 1bis with respect to the thickness of the tyre casing 100 allowing the robust tuning of the resonance of the radiating antenna of the passive radiofrequency transponder 1bis when the latter is incorporated into the tyre casing 100.

The second location for the radiofrequency transponder 1 according to the invention is ideal for the passive radiofrequency transponder 1, which is protected from any external mechanical attack and from any internal thermomechanical attack. However, it is advisable for it to be encapsulated in an electrically insulating rubber and for the first longitudinal axis of the radiating antenna to be positioned in such a way that the radiofrequency transponder 1 rests on at least two first threads of the carcass reinforcement 87. Here, in this example, the first longitudinal axis is placed circumferentially. It is preferable for the passive radiofrequency transponder 1 to be positioned inside a layer of elastomer compound of the tyre casing 100. That means that the data contained in the electronic chip of the passive radiofrequency transponder cannot be falsified when this chip has been write-protected after the first writing to the memory associated with the electronic chip. In addition, the uniformity surrounding the radiofrequency transponder 1 gives the tyre casing 100 and the passive radiofrequency transponder 1 better physical integrity.

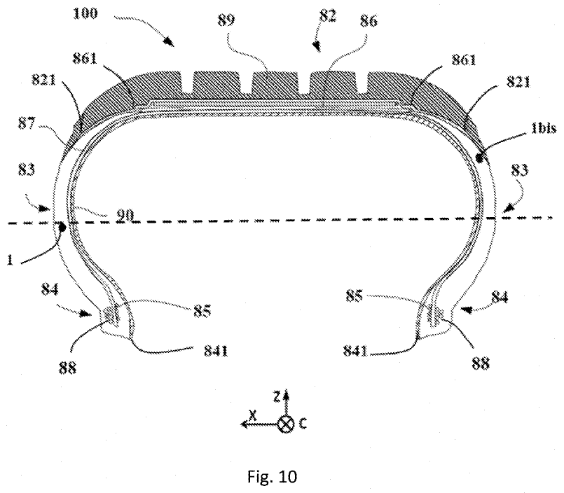

FIG. 10 depicts a view in meridian section of the tyre casing 100 corresponding to the radiofrequency transponder 1 being implanted in the sidewall 83 of the tyre casing 100. In this example, the radiofrequency transponder 1 is implanted substantially mid-way up the height of the sidewall 83 of the tyre casing 100 embodied by the dotted line. This is the ideal region in terms of radio communications, because, firstly, it is distant from the highly metallic regions of the tyre, ensuring free space on the outside of the tyre. In addition, the surrounding rubbers are soft rubbers, generally containing only a small amount of fillers, which is good for the proper radiofrequency operation of the radiofrequency transponder 1. Regarding the physical integrity of the passive radiofrequency transponder 1, although this geometric region is highly cyclically stressed as it enters the contact patch in particular, the mechanical uncoupling of the radiating dipole antenna with respect to the electronic part allows the passive radiofrequency transponder 1 a satisfactory life. Regarding the physical integrity of the tyre casing 100, the radiofrequency transponder 100 should be positioned far enough away from the free edges which in this instance are located in the outer region of the tyre casing 100. Resting against the carcass reinforcement 87, the passive radiofrequency transponder 1 which, if need be, has been encapsulated in an electrically insulating encapsulating mass, should have its first longitudinal axis positioned in such a way that its projection onto the carcass reinforcement 87 intercepts at least two first threads of the carcass reinforcement 87. Ideally, the first longitudinal axis of the radiating dipole antenna is perpendicular to the threads of the carcass reinforcement 87, which amounts to positioning it circumferentially in the case of a tyre casing 1 of radial structure. Although this region is highly stressed under operating conditions, the mechanical uncoupling between the electronic part and the radiating dipole antenna allows the passive radiofrequency transponder 1 satisfactory mechanical integrity. Ideally, in order to limit the mechanical stresses experienced by the passive radiofrequency transponder 1, the passive radiofrequency transponder 1 is not in contact with the first threads of the carcass reinforcement 87.

The second position in the sidewall 83 amounts to positioning the radiofrequency transponder 1bis inside the layer of rubber compound that defines the sidewall 83 and radially in the vicinity of the axial end 821 of the crown block 82. The advantage of this position is the uniformity of the material around the passive radiofrequency transponder 1bis, which improves the radio communications performance of the radiating antenna. In order to meet the requirements associated with the integrity of the tyre casing 100, the radiofrequency transponder ibis should be kept away from any free edge 861 of the crown reinforcement 86 or from the ends of the rubber mass that are situated in the outer region of the tyre casing 100. In particular, care will be taken to keep the radiofrequency transponder ibis at least 5 millimetres away from the free edge 861 of the crown reinforcement 86 and from the end 821 of the crown block 82. Of course, the physical integrity of the radiofrequency transponder ibis will be all the better, the further the radial position thereof is from the equator corresponding to the axial ends of the tyre which are regions frequently subjected to knocks from roadway equipment, such as curbs. Other positions, not illustrated in the drawings, are possible, notably in the interior region of the tyre casing 100 with respect to the carcass reinforcement 87. The interior region of the tyre casing is a region of natural protection for the passive radiofrequency transponder that is beneficial to its physical integrity at the expense of slightly reduced radio communications performance. This interior region also offers the advantage of limiting the number of free edges of constituent components of the tyre casing which are potential weak spots with regard to the mechanical endurance of the tyre casing fitted with the passive radiofrequency transponder.

Of course, the orientation of the radiating dipole antenna of the passive radiofrequency transponder 1 and ibis with respect to the direction defined by the first threads of the carcass reinforcement can be any orientation so long as the projection of the radiating dipole antenna intercepts at least two first threads of the carcass reinforcement. As a result, when speaking about the distance between the end of a layer and the passive radiofrequency transponder, this means the distance for each material point of the passive radiofrequency transponder in each meridian plane of the tyre casing with respect to the end of the layer in that same meridian plane. What is meant by a passive radiofrequency transponder is that this transponder is potentially equipped with an encapsulating mass. However, it is more practical for the passive radiofrequency transponder to be positioned directly in such a way that the first longitudinal axis is substantially perpendicular to the direction of the first threads of the carcass reinforcement.

1.-13. (canceled)

14. A tire casing (100) that is toroidal in shape about a reference axis and equipped with a passive radiofrequency transponder (1, 1bis) and comprises:
a crown block (82) comprising a crown reinforcement (86) having an axial end (861) at each of its edges, and a tread (89), connected at each of its axial ends (821) to a bead (84) having an interior end (841) situated axially and radially on an inside of the bead (84) with respect to the reference axis, by a sidewall (83);
first threads forming outward and return portions arranged adjacent to one another, aligned circumferentially, anchored in the beads (84) with, in each bead (84), loops each connecting an outbound and a return portion, the first threads forming at least one circumferential alignment defining a carcass reinforcement (87) dividing the tire casing into two regions, inner and outer, with respect to the carcass reinforcement (87);
in each bead (84), means of anchoring the first threads comprising second threads oriented circumferentially and axially bordering the first threads and forming at least one spiral (85, 88);
a first layer of elastomer compound (91) forming an exterior surface of the tire casing (100) in the region of the bead (84), the first layer of elastomer compound (91) being intended to come into contact with a rim;
a second layer of elastomer compound (92) situated radially on an outside in contact with the first layer of elastomer compound (91) forming an exterior surface of the sidewall (83);
the passive radiofrequency transponder (1, 1bis) comprising an electronic portion (20) and a radiating dipole antenna (10) consisting of a single-strand helicoidal spring defining a helix pitch P, a winding diameter D, a midplane (19) and a wire diameter defining an interior diameter (13) and an exterior diameter (15) of the radiating antenna (10), of which a length (L0) is designed to communicate on a frequency band with an external radiofrequency reader defining a first longitudinal axis (11), a central region and two lateral regions along the first longitudinal axis (11),
the electronic portion (20) comprising an electronic chip and a primary antenna of coil type comprising at least one turn, and defining a second longitudinal axis and a midplane (21) perpendicular to the second longitudinal axis, the primary antenna being electrically connected to the electronic chip and electromagnetically coupled to the radiating dipole antenna (10), the primary antenna being circumscribed inside a cylinder of which an axis of revolution is parallel to the second longitudinal axis and in which the diameter is greater than or equal to one third of the interior diameter (13) of the radiating antenna (10) situated plumb with the primary antenna, and
the passive radiofrequency transponder (1, 1bis, 1ter) being arranged in such a way that the first (11) and second longitudinal axes are parallel and that the midplane of the primary antenna (21) is positioned in the central region of the helical spring (10),
wherein, with the radiating dipole antenna (10) comprising a second region (102) in which the radiating dipole antenna (10) is situated plumb with the electronic portion (20) and a first region (101, 101a, 101b) in which the radiating dipole antenna (10) is not situated plumb with the electronic portion (20), a ratio between a helix pitch (P1) and a winding diameter (D1) for at least one loop of the helical spring in the first region (101, 101a, 101b) is greater than 0.8,
wherein a ratio between the helix pitch (P1) and the winding diameter (D1) of each loop of the helical spring in the first region (101, 101a, 101b) of the radiating dipole antenna (10) is less than 3,
wherein the radiating dipole antenna (10) is situated plumb with at least two first threads of the carcass reinforcement (87), and
wherein the passive radiofrequency transponder (1, 1bis) is situated axially on an outside relative to the interior end (841) of the bead (84) and radially between the radially outermost end (851) of the at least one spiral (85) and the axial end (861) of the crown reinforcement (86).

15. The tire casing (100) according to claim 14, wherein the tire casing (100) comprises at least a third layer of elastomer compound (93) situated axially on an outside of the carcass reinforcement (87) and axially on an inside of the first (91) and/or second (92) layer of elastomer compound.

16. The tire casing (100) according to claim 14, wherein, with the tire casing (100) comprising at least one airtight layer of elastomer compound (90) situated axially furthest toward an inside of the tire casing (100), the tire casing (100) comprises at least a fourth layer of elastomer compound (94) axially on an inside of the carcass reinforcement (87).

17. The tire casing (100) according to claim 14, wherein the tire casing (100) comprises at least third reinforcing threads positioned adjacently so as to constitute a reinforcing reinforcement (89).

18. The tire casing (100) according to claim 14, wherein the passive radiofrequency transponder (1, 1bis) is partially encapsulated in a mass of electrically insulating elastomer compound (3a, 3b).

19. The tire casing (100) according to claim 18, wherein a tensile elastic modulus of the encapsulating mass (3a, 3b) is lower than a tensile elastic modulus of at least one elastomer compound adjacent to the encapsulating mass (3a, 3b).

20. The tire casing (100) according to claim 18, wherein a relative dielectric constant of the encapsulating mass (3a, 3b) is lower than 10.

21. The tire casing (100) according to claim 14, wherein the passive radiofrequency transponder (1, 1bis) is situated in contact with a layer of elastomer compound (90, 91, 92, 93, 94) of the tire casing (100).

22. The tire casing (100) according to claim 21, wherein the passive radiofrequency transponder (1, 1bis) is situated at a distance of at least 5 millimeters from the ends (851, 861) of a reinforcing reinforcement (85, 86, 88, 89) of the tire casing.

23. The tire casing (100) according to claim 14, wherein, with an orientation of the first threads defining a direction of reinforcement, the first longitudinal axis (11) of the radiating dipole antenna (10) is perpendicular to the direction of reinforcement.

24. The tire casing (100) according to claim 14, wherein a ratio between the helix pitch (P2) and a winding diameter (D2) for each loop of the second region (102) is less than or equal to 0.8.

25. The tire casing (100) according to claim 14, wherein the helix pitch (P1) of the radiating dipole antenna (10), which corresponds to the helix pitch of the radiating dipole antenna (10) in the first region (101, 101a, 101b), is greater than a helix pitch (P2) of the radiating dipole antenna (10) which corresponds to the helix pitch of the radiating dipole antenna (10) in the second region (102).

26. The tire casing (100) according to claim 14, wherein, with the electronic portion (20) being placed inside the radiating dipole antenna (10), a first inside diameter D1′ of the radiating dipole antenna (10) in the first region (101, 101a, 101b) is smaller than a second inside diameter D2′ of the radiating dipole antenna (10) in a second region (102), and the electronic portion (20) is circumscribed by a cylinder of which an axis of revolution is parallel to the first longitudinal axis (11) and of which the diameter is larger than or equal to the first inside diameter D1′ of the radiating dipole antenna (10).
